(19) United States
(12) Patent Application Publication
(10) Pub. No.: US 2007/0056640 A1
(43) Pub. Date: Mar. 15, 2007

(54) FLOW CONTROL SYSTEM

(75) Inventors: Hironori Matsuzawa, Nagoya-shi, Aichi-ken (JP); Kimihito Sasao, Nagoya-shi, Aichi-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Advance Denki Kogyo Kabushiki Kaisha, Nagoya-shi (JP)

(21) Appl. No.: 11/468,554

(22) Filed: Aug. 30, 2006

(30) Foreign Application Priority Data
Sep. 9, 2005 (JP) 2005-262392
Jul. 7, 2006 (JP) 2006-187516

(51) Int. Cl. G05D 16/06

(52) U.S. Cl. 137/613

(57) ABSTRACT

A flow control system able to realize stabilization of a flow rate of fluid at a high precision even in cases where pressure fluctuation of an outlet fluid of the flow control system occurs, that is, a flow control system arranged in a supply line of fluid running from a fluid supply part to a predetermined fluid usage part, provided with a first pressure control valve part arranged on the fluid supply part side and a second pressure control valve part arranged on the fluid usage part side through the first pressure control valve part and a pressure loss part, the first pressure control valve part provided with a first pressure control mechanism maintaining the outlet fluid at a predetermined pressure by a first valve part arranged within a first valve chamber moving back and forth with respect to a first valve seat in accordance with pressure fluctuation of the inlet fluid, the second pressure control valve part provided with a second pressure control mechanism maintaining the inlet fluid at a predetermined pressure by a second valve part arranged within a second valve chamber moving back and forth with respect to a second valve seat in accordance with pressure fluctuation of the outlet fluid.

### BACKGROUND OF THE INVENTION

1. Field of the Invention

The present invention relates to a flow control system arranged in a supply line of a fluid running from a fluid supply part to a predetermined fluid usage part.

2. Description of the Related Art

In the past, as a treatment system used for the purpose of cleaning a silicon wafer etc. in the fields of semiconductor manufacture etc., for example, a batch-type cleaning system has been used (for example, see Japanese Patent Publication (A) No. 2003-86561). In this cleaning system, as shown in FIG. 9, a flow control system 210 having a pressure control valve part 220 provided with a pressure control mechanism maintaining the outlet fluid at a predetermined pressure against pressure fluctuations of the inlet fluid is arranged in a supply line K of fluid running from a fluid supply part 211 to a fluid usage part 215 where a silicon wafer is cleaned. Notation 240 is a flow meter connected to the pressure control valve part 220 and measuring the flow rate of the fluid. In this cleaning system, the pressure control valve part 220 of the flow control system 200 can suppress pressure fluctuation of the outlet fluid and control the fluid to a predetermined pressure even if the inlet side fluid pressure fluctuates and can stabilize the flow rate of the fluid supplied to the fluid usage part 215.

In this regard, in a supply line where the flow control system is arranged, if a fluctuation occurs in the fluid pressure of the outlet side (fluid usage part side) of the flow control system (for example, a change in the fluid outlet head, a change in the flow rate at another supply line during mixing by a plurality of supply lines, etc.), the flow rate of the fluid supplied from the supply line at which the flow control system is arranged is liable to change and stabilization the flow rate of the fluid is liable to become difficult or to take more time (response time worsens).

In the semiconductor manufacture and other fields in which high precision flow control is demanded, this type of change in the flow rate of the fluid has a particularly large effect. Even the slightest change in flow rate may cause a reduction in the precision of cleaning etc. Due to this, in fields where high precision flow control is demanded, flow control systems that can realize high precision stabilization of the flow rate of a fluid not only in cases where pressure fluctuations of the inlet (fluid supply part side) fluid of the flow control system occur, but also in cases where pressure fluctuation of the outlet (fluid usage part side) fluid occur, are highly wanted.

### SUMMARY OF THE INVENTION

An object of the present invention is to provide a flow control system enabling high precision stabilization of the flow rate of a fluid even in cases where pressure fluctuations of the outlet fluid of the flow control system occur.

According to the present invention, there is provided a flow control system arranged in a supply line of fluid running from a fluid supply part to a predetermined fluid usage part, the flow control system provided with a first pressure control valve part arranged on the fluid supply part side and a second pressure control valve part arranged on the fluid usage part side through the first pressure control valve part and a pressure loss part, the first pressure control valve part provided with a first pressure control mechanism maintaining the outlet fluid at a predetermined pressure by a first valve part arranged within a first valve chamber moving back and forth with respect to a first valve seat in accordance with pressure fluctuation of the inlet fluid, the second pressure control valve part provided with a second pressure control mechanism maintaining the inlet fluid at a predetermined pressure by a second valve part arranged within a second valve chamber moving back and forth with respect to a second valve seat in accordance with pressure fluctuation of the outlet fluid.

According to this, the influence of pressure fluctuation of the inlet (fluid supply part side) fluid can be suppressed by the first pressure control valve part, while the influence of pressure fluctuation of the outlet (fluid usage part side) fluid can be suppressed by the second pressure control valve part. Thus, high precision stabilization of the flow rate of the fluid supplied from the supply line to the fluid usage part is possible not only in cases where pressure fluctuation of the inlet (fluid supply part side) fluid of the flow control system occurs, but even in cases where pressure fluctuation of the outlet (fluid usage part side) fluid occurs. This is due to the fact that the differential pressure before and after the pressure loss part is maintained at a predetermined value by the first pressure control mechanism and the second pressure control mechanism.

Preferably, the fluid usage part is a manifold system having a plurality of supply lines of fluid, and the flow control system is arranged at each of the supply lines.

According to this, it is possible to stabilize at a high precision the flow rate of fluid running in each of the supply lines. In addition, particularly, during mixing of fluids, even if changing the flow rate of fluid in some of the supply lines, it is possible to mix fluids extremely suitably without being affected by the flow rates of fluids running in the other supply lines.

Preferably, the pressure loss part is a flow meter.

According to this, it is possible to determine the flow rate of the supply line at any time.

### BRIEF DESCRIPTION OF THE DRAWINGS

These and other objects and features of the present invention will become clearer from the following description of the preferred embodiments given with reference to the attached drawings, wherein:

FIG. 1 is a schematic view of the supply of fluid using a flow control system according to a first embodiment of the present invention;

FIG. 2 is a sectional view of a first pressure control valve part;

FIG. 3 is a sectional view of a second pressure control valve part;

FIG. 4 is a schematic view of the arrangement of a plurality of supply lines at a fluid usage part;

FIG. 5 is a sectional view of a second pressure control valve part of a second embodiment of the present invention;

FIG. 6 is a sectional view of a second pressure control valve part of a third embodiment of the present invention;

FIG. 7 is a sectional view of a first pressure control valve part of a fourth embodiment of the present invention;

FIG. 8 is a sectional view of a second pressure control valve part of the fourth embodiment; and

FIG. 9 is a schematic view of the supply of fluid using a conventional flow control system.

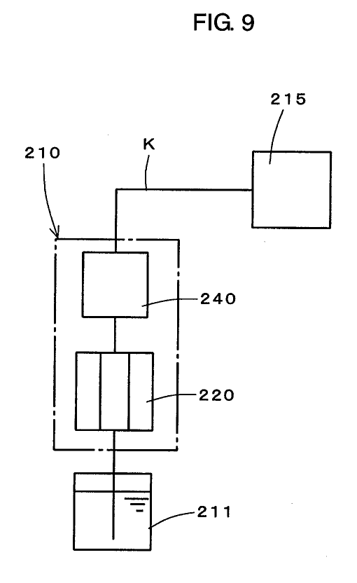

### DESCRIPTION OF THE PREFERRED EMBODIMENTS

Preferred embodiments of the present invention will be described in detail below while referring to the attached figures.

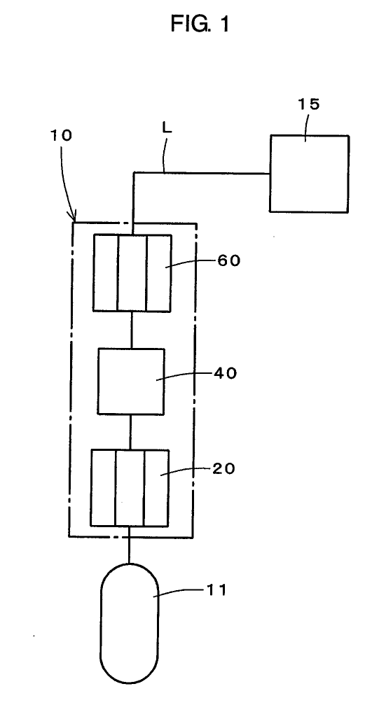

A flow control system 10 according to a first embodiment of the present invention shown in FIG. 1 is arranged at a supply line L of a fluid running from a fluid supply part 11 to a predetermined fluid usage part 15 and includes a first pressure control valve part 20 arranged on the fluid supply part 11 side and a second pressure control valve part 60 arranged on the fluid usage part 15 side through the first pressure control valve part 20 and a pressure loss part 40.

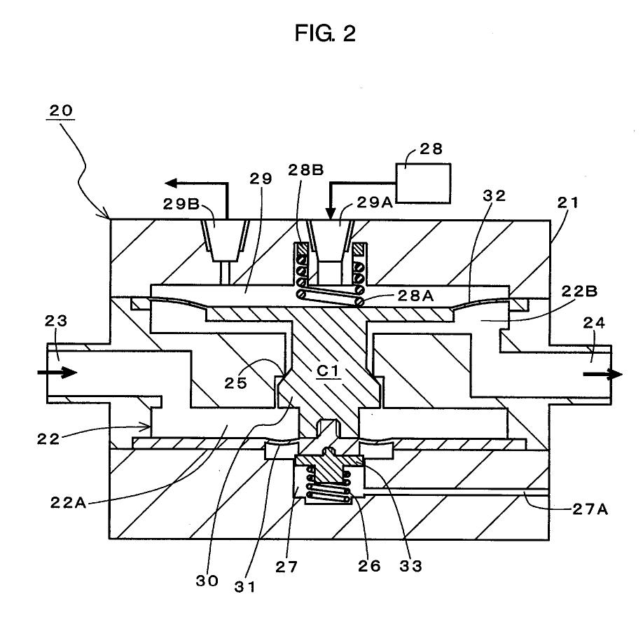

The first pressure control valve part 20, as shown in FIG. 2, is provided with a first pressure control mechanism C1 maintaining an outlet fluid at a predetermined pressure by a first valve part 30 arranged within a first valve chamber 22 moving back and forth with respect to a first valve seat 25 in accordance with pressure fluctuation of the inlet fluid. Notation 21 in the figure indicates the main body of first pressure control valve part 20, 23 indicates a first opening (inlet port) through which the inlet fluid runs, and 24 indicates a second opening (outlet port) through which the outlet fluid runs. Note that, for the first pressure control valve part 20, the inlet side expresses the fluid supply part 11 side, and the outlet side expresses the later described pressure loss part 40.

In the first pressure control mechanism C1, a first diaphragm 31 arranged at a valve chamber 22A at a first opening 23 side and a second diaphragm 32 arranged at a valve chamber 22B at a second opening 24 side are integrally formed with the first valve part 30. The diaphragms 31 and 32 are pressurized by predetermined pressures in the valve chamber 22 by pressurizing means 26 and 28, respectively. In this embodiment, the pressurizing means 26 is comprised of a spring holding the first diaphragm 31 in a constantly biased state in the valve chamber 22 direction by a constant spring load. On the other hand, the pressurizing means 28 is a pressure controlling gas controlled by an electric regulator and is comprised so as to make the first valve part 30 of the first pressure control mechanism C1 move back and forth with respect to the first valve seat 25 in accordance with the supply of the pressure controlling gas (pressurization). Further, when necessary, as shown in FIG. 2, by arranging a spring 28A at the back side of the first pressure control mechanism C1, it is possible to make a predetermined spring load act on the first pressure control mechanism C1 and increase the upper limit of the pressurization force by the pressurizing means 28. In FIG. 2, notation 27 indicates a first opening side pressurization chamber, 27A indicates a breathing passage of the first opening side pressurization chamber 27, 28B indicates a pressure control member used to control the spring load of spring 28A to a predetermined value, 29 indicates a second opening side pressurization chamber, 29A indicates a feed port used for the pressure controlling gas, 29B is an exhaust port, and 33 indicates a spring holder of the pressurizing means 26 comprised of the spring.

Further, an acidic, basic, or otherwise highly corrosive controlled fluid runs through the first pressure control valve part 20 of the embodiment, so the body 21, diaphragm 31, diaphragm 32, first pressure control mechanism C1, etc. are mainly comprised of fluororesins (PFA, PTFE, PVDF) and other various corrosion resistant and chemical resistant resins.

The pressure loss part 40 includes suitable members where pressure loss occurs arranged between the first pressure control valve part 20 and the later mentioned second pressure control valve part 60 and also a throttle part narrowing the flow passage. This pressure loss part 40, for example, may be a needle valve described in Japanese Patent Publication (A) No. 11-51217 or a shutoff valve described in Japanese Patent Publication (A) No. 2001-242940 or other valve member having a flow rate regulating mechanism. Further, in particular, the pressure loss part 40 is preferably a flow meter. For example, the flow meter of Japanese Patent No. 3184126 or Japanese Patent No. 3220283 is suitably used. If the pressure loss part 40 is made a flow meter in this way, it is possible to determine the flow rate of the supply line L at any time.

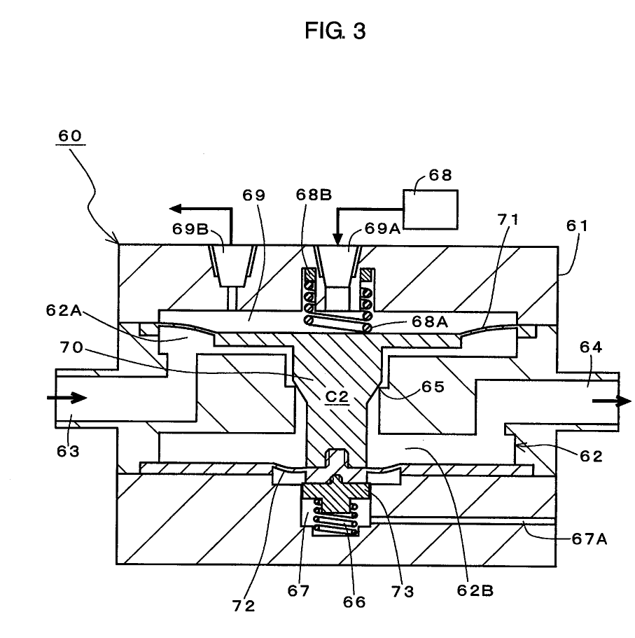

The second pressure control valve part 60, as shown in FIG. 3, is provided with a second pressure control mechanism C2 maintaining the inlet fluid at a predetermined pressure by a second valve part 70 arranged within a second valve chamber 62 moving back and forth with respect to a second valve seat 65 in accordance with pressure fluctuation of the outlet fluid. Notation 61 in the drawing indicates the body of the second pressure control valve part 60, 63 indicates a first opening (inlet port) through which the inlet fluid runs, and 64 indicates a second opening (outlet port) through which the outlet fluid runs. Note that, for the second pressure control valve part 60, the inlet sides expresses the pressure loss part 40 side and the outlet side expresses the fluid usage part 15 side.

In the second pressure control mechanism C2, a first diaphragm 71 arranged at a valve chamber 62A at a first opening 63 side and a second diaphragm 72 arranged at a valve chamber 62B at a second opening 64 side are integrally formed with a second valve part 70. The diaphragm 71 and 72 are pressurized to predetermined pressures in the valve chamber 62 direction by pressurizing means 66 and 68, respectively. In this embodiment, the pressurizing means 66 is comprised of a spring holding the second diaphragm 72 in a constantly biased state in the valve chamber 62 direction by a constant spring load. On the other hand, the pressurizing means 68 is a pressure controlling gas controlled by an electric regulator and is comprised so as to make the second valve part 70 of the second pressure control mechanism C2 move back and forth with respect to the second valve seat 65 in accordance with the supply of the pressure controlling gas (pressurization). Further, when necessary, as shown in FIG. 3, by arranging a spring 68A at the back side of the second pressure control mechanism C2, it is possible to make a predetermined spring load act on the second pressure control mechanism C2 and increase the upper limit of the pressurization force by the pressurizing means 68. Further, in this embodiment, a pressurizing means 66 comprised of a spring was used, however, as shown, the second valve part 70 of the second pressure control mechanism C2 is designed to move back and forth with respect to the second valve seat 65 by the pressurizing means 68, therefore the pressurizing means 66 need not be provided in some cases. Further, in FIG. 3, notation 67 indicates a second opening side pressurization chamber, 67A indicates a breathing passage of the second opening side pressurization chamber 67, 68B indicates a pressure control member used to control the spring load of the spring 68A to a predetermined value, 69 indicates first opening side pressurization chamber, 69A indicates a feed port used for the pressure controlling gas, 69B indicate an exhaust port, and 73 indicates a spring holder of the pressurizing means 66 comprised of a spring.

Further, an acidic, basic, or otherwise highly corrosive controlled fluid runs through the second pressure control valve part 60 of the embodiment, so the body 61, diaphragm 71, diaphragm 72, second pressure control mechanism C2, etc. are mainly comprised of fluororesins (PFA, PTFE, PVDF) and other various corrosion resistant and chemical resistant resins as with the first pressure control valve part 20.

Next, flow control using the flow control system 10 comprised as explained above will be explained. The first pressure control valve part 20 shown in FIG. 1 and FIG. 2 is what is called a “pressure reducing valve”. When pressure fluctuation occurs at the inlet (fluid supply part 11 side) fluid, the first valve part 30 of the first pressure control mechanism C1 is moved back and forth with respect to the first valve seat 25 by the pressure controlling gas constituting the pressurizing means 28 whereby the outlet (pressure loss part 40 side) fluid is maintained at a predetermined pressure and the flow rate is controlled.

On the other hand, the second pressure control valve part 60, shown in FIG. 1 and FIG. 3, is what is called a back pressure control valve. When pressure fluctuation occurs at the outlet (fluid usage part 15 side) fluid, the second valve part 70 of the second pressure control mechanism C2 is moved back and forth with respect to the second valve seat 65 by the pressure controlling gas constituting the pressurizing means 68, whereby the inlet (pressure loss part 40 side) fluid is maintained at a predetermined pressure and flow rate is controlled.

In this way, as the influence of pressure fluctuation of the inlet (fluid supply part 11 side) fluid is suppressed by the first pressure control mechanism C1 of the first pressure control valve part 20 and pressure fluctuation of the outlet (fluid usage part 15 side) fluid is suppressed by the second pressure control mechanism C2 of the second pressure control valve part 60, so the differential pressure before and after the pressure loss part 40 is maintained at a predetermined value. Therefore, in the flow control system 10 having the first pressure control valve part 20 and the second pressure control valve part 60 arranged at the fluid usage part 15 side through the pressure loss part 40, high precision stabilization of the flow rate of the fluid from the supply line L to the fluid usage part 15 is possible not only in cases where pressure fluctuation of the inlet (fluid supply part 11 side) fluid occurs, but also in cases where pressure fluctuation of the outlet (fluid usage part 15 side) fluid occurs.

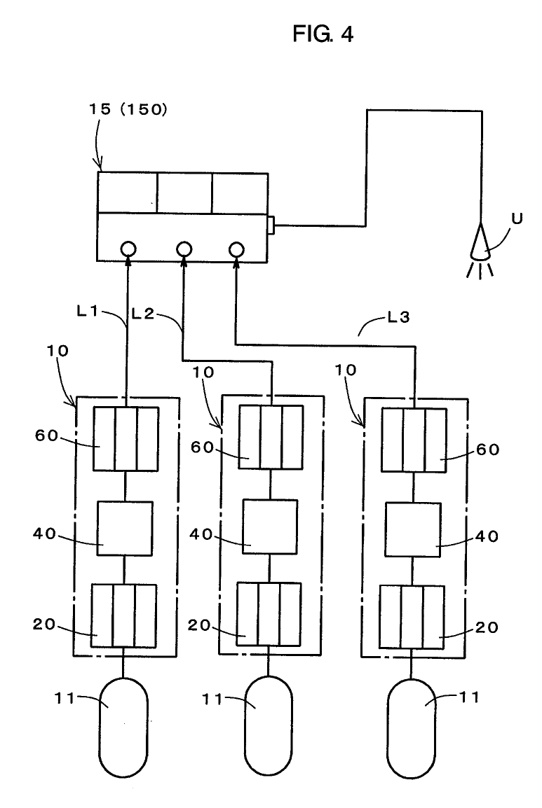

Next, other embodiments using the flow control system 10 of the present invention will be explained. In the embodiment shown in FIG. 4, the fluid usage part 15 is a manifold system 150 having a plurality of (three in this example) supply lines L1, L2, L3 of fluid. The flow control system 10 is arranged at each of the supply lines L1, L2, L3. In this embodiment, notations the same as the embodiment shown from FIG. 1 to FIG. 3 express the same components and their explanations will be omitted.

The manifold system 150 is a mechanism used to run a plurality of types of fluid, unmixed or mixed, into a treatment part U. For example, the mixing valve etc. described in Japanese Patent 3207782 can be used.

As in this embodiment, even when a plurality of supply lines L1, L2, L3 are arranged at the manifold system 150, high precision stabilization of the flow rate of the fluid running through each of the supply lines L1, L2, L3 is possible by arranging the flow control system 10 of the present invention at each of the supply lines L1, L2, L3. In particular, during mixing of fluids, even if changing the flow rate of fluid in some of the supply lines, it is possible to mix fluids extremely suitably without being affected by the flow rates of fluids running in the other supply lines.

Note that the flow control system of the present invention is not limited to the above embodiments. Parts of its composition can be suitably changed to an extent not departing from the gist of the invention. For example, it is possible to provide a flow meter, provide a controller sending control signals to the first pressure control valve part or the second pressure control part based on a signal from the flow meter, and thereby perform feedback control. In particular, when making the fluid usage part a manifold system, providing a plurality of supply lines, and mixing fluids, it is possible to control the flow rate of each of the supply lines with an extremely high precision without mutual interference of feedback control of the supply lines.

Further, in the above embodiments, the bodies 21, 61 of the first pressure control valve part 20 and the second pressure control valve part 60 have the spring 28A and spring 68A having predetermined spring loads arranged inside them. However, it is also possible to provide mechanisms outside the bodies 21 and 61 enabling manual adjustment of the spring loads.

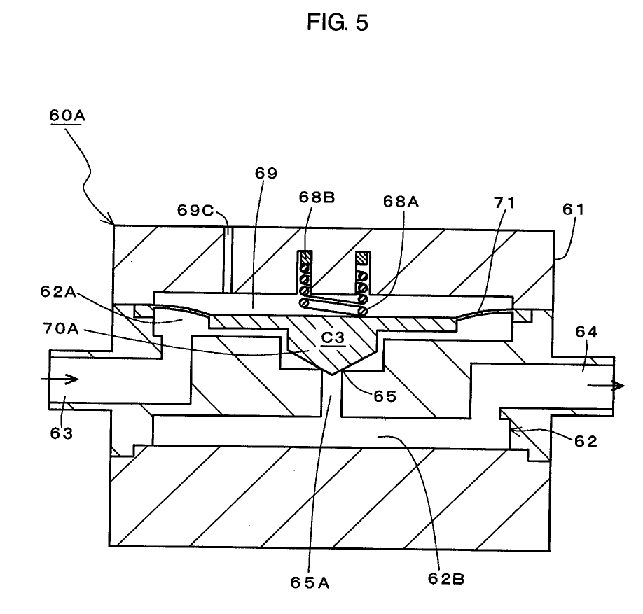

Further, the configurations of the first pressure control valve part and the second pressure control valve part in the flow control system and their combinations are not limited to only the above embodiments and may be suitably changed. For example, the flow control system of the second embodiment is comprised of a combination of the first pressure control valve part 20 shown in FIG. 2 and a second pressure control valve part 60A shown in FIG. 5. Note that, in the following embodiments, notations the same as with the previous embodiments indicate the same components and their explanations will be omitted.

The second pressure control valve part 60A, as shown in FIG. 5, is provided with a second pressure control mechanism C3 comprised of the first diaphragm 71 arranged at the valve chamber 62A at the first opening 63 side formed integrally with the second valve part 70A. By arranging the spring 68A as a pressurizing means at the back side of the second pressure control valve part 60A and causing action of a predetermined pressurizing force, the second valve part 70A of the second pressure control mechanism C3 is biased to the second valve seat 65 side. Note that in the example shown in the figure, while an orifice part 65A is connected with the second opening 64 through the valve chamber 62B of the second opening 64 side, but it is also possible to directly connect the orifice part 65A and the second opening 64. Further, notation 69C in the figure indicates the breathing passage of the first opening side pressurization chamber 69.

In the flow control system of the second embodiment comprised as explained above as well, as in the flow control system 10, the influence of pressure fluctuation of the inlet (fluid supply part 11 side) fluid is suppressed by the first pressure control mechanism C1 of the first pressure control valve part 20 and pressure fluctuation of the outlet (fluid usage part 15 side) fluid is suppressed by the pressure control mechanism C3 of the second pressure control valve part 60A, so the differential pressure before and after the pressure loss part 40 can be maintained at a predetermined value.

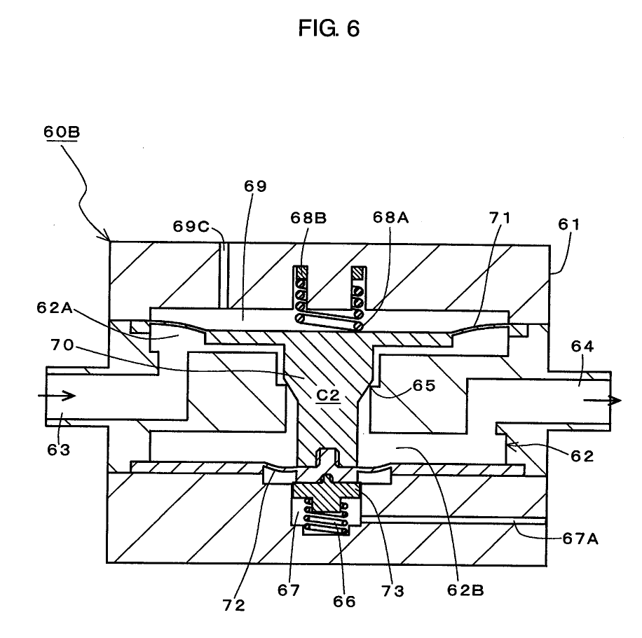

The flow control system of a third embodiment of the invention is comprised of a combination of the first pressure control valve part 20 shown in FIG. 2 and a second pressure control valve part 60B shown in FIG. 6. The second pressure control valve part 60B, as shown in FIG. 6, is provided with the second pressure control mechanism C2 comprised of the first diaphragm 71 arranged at the valve chamber 62A of the first opening 63 side and the second diaphragm 72 arranged at the valve chamber 62B at second opening 64 side formed integrally with the second valve part 70. Further, it is comprised so that it makes the second valve part 70 of the second pressure control mechanism C2 move back and forth with respect to the second valve seat 65 in accordance with the supply of the pressure controlling gas controlled (pressurization) by the electric regulator constituting the pressurizing means 68.

In the flow control system of the third embodiment comprised as explained above as well, as in the flow control system 10, the influence of pressure fluctuation of the inlet (fluid supply part 11 side) fluid is suppressed by the first pressure control mechanism C1 of the first pressure control valve part 20 and pressure fluctuation of the outlet (fluid usage part 15 side) fluid is suppressed by the second pressure control mechanism C2 of the second pressure control valve part 60B, so the differential pressure before and after the pressure loss part 40 can be maintained at a predetermined value.

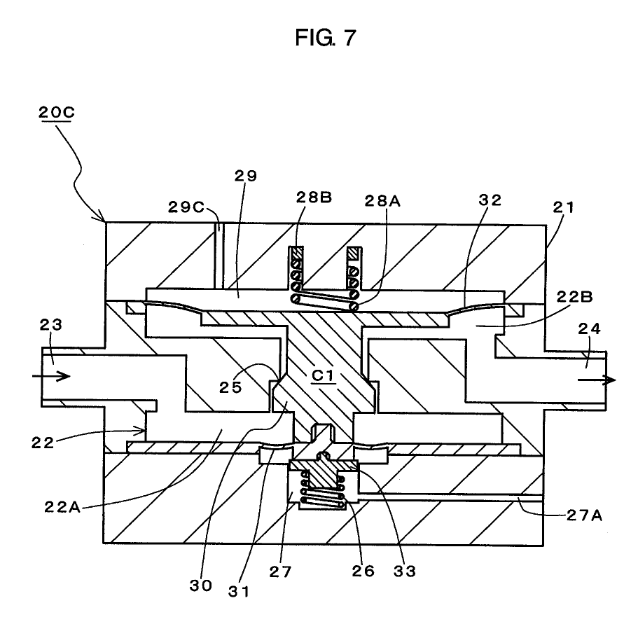

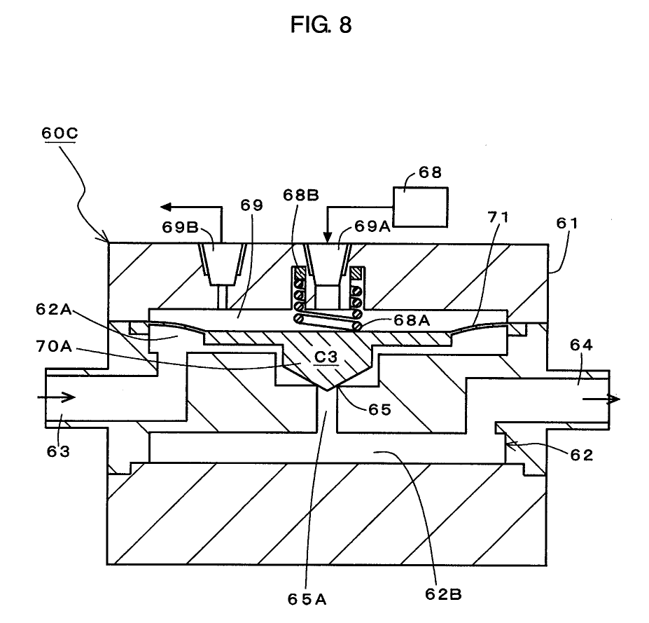

The flow control system 10 of the fourth embodiment is comprised of a combination of a first pressure control valve part 20C shown in FIG. 7 and a second pressure control valve part 60C shown in FIG. 8. The first pressure control valve part 20C, as shown in FIG. 7, is provided with a first pressure control mechanism C1 comprised of the first diaphragm 31 arranged at the valve chamber 22A at the first opening 23 side and the second diaphragm 32 arranged at the valve chamber 22B at the second opening 24 side formed integrally with the first valve part 30. Further, it arranges a spring 28C as the pressurizing means at the back side of the first pressure control valve part 20C to make a predetermined pressurizing force act. In this figure, notation 29C indicates a breathing passage of the second opening side pressurization chamber 29.

Further, the second pressure control valve part 60C, as shown in FIG. 8, is provided with the second pressure control mechanism C3 comprised of the first diaphragm 71 arranged at the valve chamber 62A at the first opening 63 side formed integrally with the second valve part 70A. Further, it is comprised to make the second valve part 70A of the second pressure control mechanism C3 move back and forth with respect to the second valve seat 65 in accordance with the supply of the pressure controlling gas (pressurization) controlled by the electric regulator constituting the pressurizing means 68. Note that in the example shown in the figure, while an orifice part 65A is connected with the second opening 64 through the valve chamber 62B of the second opening 64 side, but it is also possible to directly connect the orifice part 65A and the second opening 64.

In the flow control system of the fourth embodiment comprised as explained above as well, as in the flow control system 10, the influence of pressure fluctuation of the inlet (fluid supply part 11 side) fluid is suppressed by the first pressure control mechanism C1 of the first pressure control valve part 20C and pressure fluctuation of the outlet (fluid usage part 15 side) fluid is suppressed by the second pressure control mechanism C3 of the second pressure control valve part 60C, so the differential pressure before and after the pressure loss part 40 can be maintained at a predetermined value.

As will be understood well from the above explanation of the configurations of the first pressure control valve part and the second pressure control valve part in the flow control system and their combinations given with reference to the first to fourth embodiments, the combinations K1 to K24 shown in Table 1 can be worked by the combinations of the configurations of the inlet pressurizing means and the outlet pressurizing means in the first pressure control valve part and the configurations of the inlet pressurizing means and the outlet pressurizing means and diaphragms formed at the second pressure control mechanism in the second pressure control valve part.

TABLE 1

| | First pressure control valve part | | Second pressure control valve part | | |
|---|---|---|---|---|---|
| | Inlet | Outlet | Inlet | Outlet | |
| | pressurizing | pressurizing | pressurizing | pressurizing | |
| Combination | means | means | means | means | Diaphragm |
| K1 | Spring | Pressure con- | Spring | Spring or no | Inlet, |
| | | trolling gas | | spring | outlet |
| K2 | Spring | Pressure con- | Spring | Pressure con- | Inlet, |
| | | trolling gas | | trolling gas | outlet |
| K3 | Spring | Pressure con- | Pressure con- | Spring or no | Inlet, |
| | | trolling gas | trolling gas | spring | outlet |
| K4 | Spring | Pressure con- | Pressure con- | Pressure con- | Inlet, |
| | | trolling gas | trolling gas | trolling gas | outlet |
| K5 | Spring | Pressure con- | Spring | — | Inlet |
| | | trolling gas | | | |
| K6 | Spring | Pressure con- | Pressure con- | — | Inlet |
| | | trolling gas | trolling gas | | |
| K7 | Pressure con- | Pressure con- | Spring | Spring or no | Inlet, |
| | trolling gas | trolling gas | | spring | outlet |
| K8 | Pressure con- | Pressure con- | Spring | Pressure con- | Inlet, |
| | trolling gas | trolling gas | | trolling gas | outlet |
| K9 | Pressure con- | Pressure con- | Pressure con- | Spring or no | Inlet, |
| | trolling gas | trolling gas | trolling gas | spring | outlet |
| K10 | Pressure con- | Pressure con- | Pressure con- | Pressure con- | Inlet, |
| | trolling gas | trolling gas | trolling gas | trolling gas | outlet |
| K11 | Pressure con- | Pressure con- | Spring | — | Inlet |
| | trolling gas | trolling gas | | | |
| K12 | Pressure con- | Pressure con- | Pressure con- | — | Inlet |
| | trolling gas | trolling gas | trolling gas | | |
| K13 | Spring or no | Spring | Spring | Spring or no | Inlet, |
| | spring | | | spring | outlet |
| K14 | Spring or no | Spring | Spring | Pressure con- | Inlet, |
| | spring | | | trolling gas | outlet |
| K15 | Spring or no | Spring | Pressure con- | Spring or no | Inlet, |
| | spring | | trolling gas | spring | outlet |
| K16 | Spring or no | Spring | Pressure con- | Pressure con- | Inlet, |
| | spring | | trolling gas | trolling gas | outlet |
| K17 | Spring or no | Spring | Spring | — | Inlet |
| | spring | | | | |
| K18 | Spring or no | Spring | Pressure con- | — | Inlet |
| | spring | | trolling gas | | |
| K19 | Pressure con- | Spring | Spring | Spring or no | Inlet, |
| | trolling gas | | | spring | outlet |
| K20 | Pressure con- | Spring | Spring | Pressure con- | Inlet, |
| | trolling gas | | | trolling gas | outlet |
| K21 | Pressure con- | Spring | Pressure con- | Spring or no | Inlet, |
| | trolling gas | | trolling gas | spring | outlet |
| K22 | Pressure con- | Spring | Pressure con- | Pressure con- | Inlet, |
| | trolling gas | | trolling gas | trolling gas | outlet |
| K23 | Pressure con- | Spring | Spring | — | Inlet |
| | trolling gas | | | | |
| K24 | Pressure con- | Spring | Pressure con- | — | Inlet |
| | trolling gas | | trolling gas | | |

The combination K1 expresses the combination of a first pressure control valve part and a second pressure control valve part of the third embodiment.

The combination K2 expresses the combination of a first pressure control valve part in which the inlet pressurizing means is comprised of a spring and the outlet pressurizing means is comprised of a pressure controlling gas and a second pressure control valve part in which diaphragms are formed at the inlet and outlet of the second pressure control mechanism and the inlet pressurizing means is comprised of a spring and the outlet pressurizing means is comprised of a pressure controlling gas.

The combination K3 expresses the combination of a first pressure control valve part and a second pressure control valve part of the first embodiment.

The combination K4 expresses the combination of a first pressure control valve part in which the inlet pressurizing means is comprised of a spring and the outlet pressurizing means is comprised of a pressure controlling gas and a second pressure control valve part in which diaphragms are formed at the inlet and outlet of the second pressure control mechanism and the inlet pressurizing means is comprised of a pressure controlling gas and the outlet means is comprised of a pressure controlling gas.

The combination K5 expresses the combination of a first pressure control valve part and a second pressure control valve part of the second embodiment.

The combination K6 expresses the combination of a first pressure control valve part in which the inlet pressurizing means is comprised of a spring and the outlet pressurizing means is comprised of a pressure controlling gas and a second pressure control valve part in which a diaphragm is formed at only the inlet of the second pressure control mechanism and the inlet pressurizing means is comprised of a pressure controlling gas.

The combination K7 expresses the combination of a first pressure control valve part in which the inlet pressurizing means is comprised of a pressure controlling gas and the outlet pressurizing means is comprised of a pressure controlling gas and a second pressure control valve part in which diaphragms are formed at the inlet and outlet of the second pressure control mechanism and the inlet pressurizing means is comprised of a spring and the outlet pressurizing means is comprised of a spring (or there is no means).

The combination K8 expresses the combination of a first pressure control valve part in which the inlet pressurizing means is comprised of a pressure controlling gas and the outlet pressurizing means is comprised of a pressure controlling gas and a second pressure control valve part in which diaphragms are formed at the inlet and outlet of the second pressure control mechanism and the inlet pressurizing means is comprised of a spring and the outlet pressurizing means is comprised of a pressure controlling gas.

The combination K9 expresses the combination of a first pressure control valve part in which the inlet pressurizing means is comprised of a pressure controlling gas and the outlet pressurizing means is comprised of a pressure controlling gas and a second pressure control valve part in which diaphragms are formed at the inlet and outlet of the second pressure control mechanism and the inlet pressurizing means is comprised of a pressure controlling gas and the outlet pressurizing means is comprised of a spring (or there is no means).

The combination K10 expresses the combination of a first pressure control valve part in which the inlet pressurizing means is comprised of a pressure controlling gas and the outlet pressurizing means is comprised of a pressure controlling gas and a second pressure control valve part in which diaphragms are formed at the inlet and outlet of the second pressure control mechanism and the inlet pressurizing means is comprised of a pressure controlling gas and the outlet pressurizing means is comprised of a pressure controlling gas.

The combination K11 expresses the combination of a first pressure control valve part in which the inlet pressurizing means is comprised of a pressure controlling gas and the outlet pressurizing means is comprised of a pressure controlling gas and a second pressure control valve part in which a diaphragm is formed at only the inlet of the second pressure control mechanism and the inlet pressurizing means is comprised of a spring.

The combination K12 expresses the combination of a first pressure control valve part in which the inlet pressurizing means is comprised of a pressure controlling gas and the outlet pressurizing means is comprised of a pressure controlling gas and a second pressure control valve part in which a diaphragm is formed at only the inlet of the second pressure control mechanism and the inlet pressurizing means is comprised of a pressure controlling gas.

The combination K13 expresses the combination of a first pressure control valve part in which the inlet pressurizing means is comprised of a spring (or has none) and the outlet pressurizing means is comprised of a spring and a second pressure control valve part in which diaphragms are formed at the inlet and outlet of the second pressure control mechanism and the inlet pressurizing means is comprised of a spring and the outlet pressurizing means is comprised of a spring (or has none).

The combination K14 expresses the combination of a first pressure control valve part in which the inlet pressurizing means is comprised of a spring (or has none) and the outlet pressurizing means is comprised of a spring and a second pressure control valve part in which diaphragms are formed at the inlet and outlet of the second pressure control mechanism and the inlet pressurizing means is comprised of a spring and the outlet pressurizing means is comprised of a pressure controlling gas.

The combination K15 expresses the combination of a first pressure control valve part in which the inlet pressurizing means is comprised of a spring (or has none) and the outlet pressurizing means is comprised of a spring and a second pressure control valve part in which diaphragms are formed on the inlet and outlet of the second pressure control mechanism and the inlet pressurizing means is comprised of a pressure controlling gas and the outlet pressurizing means is comprised of a spring (or has none).

The combination K16 expresses the combination of a first pressure control valve part in which the inlet pressurizing means is comprised of a spring (or has none) and the outlet pressurizing means is comprised of a spring and a second pressure control valve part in which diaphragms are formed at the inlet and outlet of the second pressure control mechanism and the inlet pressurizing means is comprised of a pressure controlling gas and the outlet pressurizing means is comprised of a pressure controlling gas.

The combination K17 expresses the combination of a first pressure control valve part in which the inlet pressurizing means is comprised of a spring (or has none) and the outlet pressurizing means is comprised of a spring and a second pressure control valve part in which a diaphragm is formed at only the inlet of the second pressure control mechanism and the inlet pressurizing means is comprised of a spring.

The combination K18 expresses the combination of a first pressure control valve part and a second pressure control valve part of the fourth embodiment.

The combination K19 expresses the combination of a first pressure control valve part in which the inlet pressurizing means is comprised of a pressure controlling gas and the outlet pressurizing means is comprised of a spring and a second pressure control valve part in which diaphragms are formed at the inlet and outlet of the second pressure control mechanism and the inlet pressurizing means is comprised of a spring and the outlet pressurizing means is comprised of a spring (or has none).

The combination K20 expresses the combination of a first pressure control valve part in which the inlet pressurizing means is comprised of a pressure controlling gas and the outlet pressurizing means is comprised of a spring and a second pressure control valve part in which diaphragms are formed at the inlet and outlet of the second pressure control mechanism and the inlet pressurizing means is comprised of a spring and the outlet pressurizing means is comprised of a pressure controlling gas.

The combination K21 expresses the combination of a first pressure control valve part in which the inlet pressurizing means is comprised of a pressure controlling gas and the outlet pressurizing means is comprised of a spring and a second pressure control valve part in which diaphragms are formed at the inlet and outlet of the second pressure control mechanism and the inlet pressurizing means is comprised of a pressure controlling gas and the outlet pressurizing means is comprised of a spring (or has none).

The combination K22 expresses the combination of a first pressure control valve part in which the inlet pressurizing means is comprised of a pressure controlling gas and the outlet pressurizing means is comprised of a spring and a second pressure control valve part in which diaphragms are formed at the inlet and outlet of the second pressure control mechanism and the inlet pressurizing means is comprised of a pressure controlling gas and the outlet pressurizing means is comprised of a pressure controlling gas.

The combination K23 expresses the combination of a first pressure control valve part in which the inlet pressurizing means is comprised of a pressure controlling gas and the outlet pressurizing means is comprised of a spring and a second pressure control valve part in which a diaphragm is formed at only the inlet of the second pressure control mechanism and the inlet pressurizing means is comprised of a spring.

The combination K24 expresses the combination of a first pressure control valve part in which the inlet pressurizing means is comprised of a pressure controlling gas and the outlet pressurizing means is comprised of a spring and a second pressure control valve part in which a diaphragm is formed at only the inlet of the second pressure control mechanism and the inlet pressurizing means is comprised of a pressure controlling gas.

1. A flow control system arranged in a supply line of fluid running from a fluid supply part to a predetermined fluid usage part,
said flow control system provided with a first pressure control valve part arranged on said fluid supply part side and a second pressure control valve part arranged on said fluid usage part side through said first pressure control valve part and a pressure loss part,
said first pressure control valve part provided with a first pressure control mechanism maintaining the outlet fluid at a predetermined pressure by a first valve part arranged within a first valve chamber moving back and forth with respect to a first valve seat in accordance with pressure fluctuation of the inlet fluid,
said second pressure control valve part provided with a second pressure control mechanism maintaining the inlet fluid at a predetermined pressure by a second valve part arranged within a second valve chamber moving back and forth with respect to a second valve seat in accordance with pressure fluctuation of the outlet fluid.

2. A flow control system as set forth in claim 1, wherein said fluid usage part is a manifold system having a plurality of supply lines of fluid and wherein said flow control system is arranged at each of said supply lines.

3. A flow control system as set forth in claim 1, wherein said pressure loss part is a flow meter.
